(19) United States
(12) Patent Application Publication
(10) Pub. No.: US 2023/0115442 A1
(43) Pub. Date: Apr. 13, 2023

(54) Flexible Waterproofing/Impregnation and Drying Device

(71) Applicant: IMBOX PROTECTION A/S, Egå (DK)

(72) Inventors: René Marker, Auning (DK); Henrik Grundtvig, Risskov (DK)

(73) Assignee: IMBOX PROTECTION A/S, Egå (DK)

(21) Appl. No.: 17/914,915

(22) PCT Filed: Apr. 8, 2021
(86) PCT No.: PCT/DK2021/050099

§ 371 Date: Sep. 27, 2022

(30) Foreign Application Priority Data
Apr. 8, 2020 (DK) PA 2020 70217
Apr. 15, 2020 (DK) PA 2020 70234
Jun. 30, 2020 (DK) PA 2020 70434

(51) Int. Cl. A43D 95/06; F26B 5/00; A43D 95/10

(52) U.S. Cl. CPC A43D 95/06; F26B 5/005; A43D 95/10; A43B 7/12

(57) ABSTRACT

The present invention relates to a flexible waterproofing/impregnation and drying de-vice and a method of drying items that have undergone a solvent-based or water-based waterproofing/impregnation process. The flexible waterproofing/impregnation and dry-ing device is configured with inlets for waterproofing/impregnation fluid for water-proofing/impregnating items and one or more heat generating units for effective drying of items, said items being for example clothes, shoes, bags, purses, blankets and garments.

### FIELD OF THE INVENTION

The present invention relates to a waterproofing/impregnation and drying device and a method of drying items that have undergone a solvent-based or water-based waterproofing/impregnation process. The present invention also relates to the use of a waterproofing/impregnation and drying device for drying items that have undergone a solvent-based or water-based waterproofing/impregnation process, such as clothes, shoes, bags, purses, blankets and garments.

### BACKGROUND OF THE INVENTION

Waterproofing/impregnation devices are well known in the art, and as well are drying devices for drying items such as shoes and clothes. Items to be waterproofed/impregnated are usually subjected to a waterproofing/impregnation process in one device, and subsequently subject to drying in another devise. The process is often cumbersome and requires different devices and is relatively time-consuming.

### OBJECT OF THE INVENTION

Hence, there is a need for a more versatile and flexible waterproofing/impregnation device that is able to waterproof/impregnate and subsequently dry the items in a single device using a simple process that requires a very short operation time.

It is an object of the present invention to fulfil the need of improving the state of the art of waterproofing/impregnating and drying items such as clothes, shoes, bags, purses, blankets and garments, to overcome the problems described in the prior art having separate devices and processes, and to improve known waterproofing/impregnation devices and processes by providing a very flexible waterproofing/impregnation and drying device. The device is flexible in that it is both capable of waterproofing/impregnating items with a solvent-based or water-based waterproofing/impregnation fluid, and drying said items using one or more heat generating units, said heat generating units configured to provide heat in one or more different forms. Mostly the device will be utilising both functionalities, but it is foreseen that in certain cases only one or the other procedure may be used.

The waterproofing/impregnation and drying device of the present invention is very versatile and flexible, both in respect of the choice of waterproofing/impregnation fluid introduced into the device, in which way the waterproofing/impregnation fluid is applied onto the items being waterproofed/impregnated and/or dried, which and how many of heat generating units is used to dry the items after waterproofing/impregnation, and how to control the device.

In one embodiment, an air condition unit is suggested as a means on how to provide drying to the items having been treated. At least within this description and claims, air condition shall be understood as the air condition unit treats the air being introduced into the treatment/drying chamber according to predefined parameters, such that the air may be cooler, warmer, have higher or lower relative humidity than the ambient air. The air condition unit may also provide the exiting air with a predefined velocity in order to obtain sufficient/desirable air exchange inside the device.

Waterproofing/impregnation shall be understood as a treatment of items such as for example shoes are exposed to in the device and during the method according to the invention, which treatment renders the items, if not completely waterproof then with an improved resistance against getting wet, at least for a period of time.

At least within the present invention “fluid” shall be understood as a substance that continually deforms under an applied shear stress, or external force. Fluids are a phase of matter and include liquids, gases and plasmas. They are substances with zero shear modulus, or, in simpler terms, substances which cannot resist any shear force applied to them. The term “fluid” therefore includes both the liquid and gas phases. Particularly with respect to the present invention, the impregnating fluid comprises an air fraction and an impregnating agent. The impregnating agent typically comprises a siccative, a silicone component or other impregnating agent and possible other active ingredients as well as a solvent. The impregnating agent or waterproofing/impregnation fluid is typically a liquid, where, in use with the present invention droplets are suspended in an airstream when being applied to an object.

In a further advantageous embodiment of the invention the one or more inlets comprises one or more nozzles, and where said inlets are connected to a source of impregnating material by means of conduits, and where emptying means are provided for emptying the conduits of impregnating material between each activation of the device. This embodiment is particularly interesting in that it is easy and fast to change from one impregnating liquid to another, or in treatments involving impregnating agents comprising a hardener, the liquid is ejected before the hardening agent becomes active potentially clogging up the impregnating system (conduits, nozzles etc.).

In one particular embodiment, the emptying means comprises a connection to a source of pressurized gas or a cleaning liquid, such that said pressurized gas or liquid may be introduced into the conduit, ejecting any impregnating agent.

Hence, in a first aspect it is an object of the present invention to provide a waterproofing/impregnation and drying device for waterproofing/impregnating and drying items wherein said device comprises a chamber, one or more inlets for introducing waterproofing/impregnation fluid into the chamber, means for supplying air to the chamber, agitating the air inside the chamber and extracting the air from the chamber, wherein the device comprises one or more heat generating units (6).

In a second aspect it is an object of the present invention to provide a method of waterproofing/impregnating and drying items comprising the steps of
a. placing said items in the device;
b. configuring the device via the electronic display and input device or by remote control of the electrical means to select and control the one or more inlets to control the flow of waterproofing/impregnation fluid into the camber;
c. configuring the device via the electronic display and input device or by remote control of the electrical means to configure the one or more heat generating units;
d. configuring the device via the electronic display and input device or by remote control of the electrical means to configure the means for supplying air to the chamber, agitating the air inside the chamber and extracting the air from the chamber;
e. waterproofing/impregnating and subsequently drying said items for a fixed time period specified by operating the electronic display and input device or by remote control of the electrical means configured to control the flexible drying device.

In a third aspect it is an object of the present invention to make use of a waterproofing/impregnation and drying device for drying items, wherein said items are clothes, shoes, bags, purses, blankets, garments and the like having undergone a solvent-based or water-based waterproofing/impregnation process.

### DESCRIPTION OF THE DRAWINGS

Figure reference list:

| | |
|---|---|
| Flexible waterproofing/impregnation and drying device | 1 |
| Chamber | 2 |
| Means for supplying, agitating and/or extracting air | 4 |
| Heat generating unit | 6 |
| Chamber door | 8 |
| Inlet | 10 |
| Items to be waterproofed/impregnated and dried | 12 |
| Rotating shelve | 14 |
| Electronic display and input device | 16 |
| Remote controllable electrical means | 17 |
| Sprayer | 18 |
| Support for mounting of a shelve | 20 |

FIG. 1 shows a front view of the waterproofing/impregnation and drying device (1) of the present invention comprising a chamber (2), means for supplying, agitating and/or extracting air (4) to and from the chamber, heat generating units (6), chamber doors (8), inlets (10) for supplying waterproofing/impregnation fluids, an electronic display and input device (16), and remote controllable electrical means (17) for controlling the flexible waterproofing/impregnation and drying device (1).

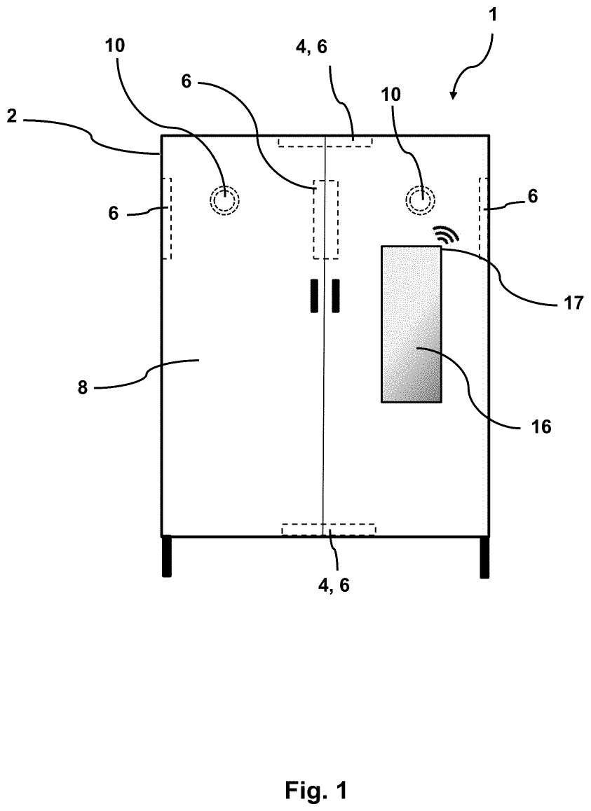

FIG. 2 shows the interior of the flexible waterproofing/impregnation and drying device (1) of the present invention comprising a chamber (2), means for supplying, agitating and/or extracting air (4) to and from the chamber, heat generating units (6), inlets (10) for supplying waterproofing/impregnation fluids, sprayer (18) for applying waterproofing/impregnation fluids onto the items (12) to be waterproofed/impregnated and subsequently dried, and a shelve (14).

In this embodiment of the present invention the shelf is a rotatable shelf configured to rotate the items to be waterproofed/impregnated or dried, and the device (1) comprises two sprayers for waterproofing/impregnating the items.

FIG. 3 shows the interior of the flexible waterproofing/impregnation and drying device (1) of the present invention comprising a chamber (2), means for supplying, agitating and/or extracting air (4) to and from the chamber, heat generating units (6), sprayer (18) for applying waterproofing/impregnation fluids onto the items (12) to be waterproofed/impregnated and subsequently dried, and shelves (14).

In this embodiment the device (1) comprises two shelves and a rotatable sprayer for waterproofing/impregnation the items.

FIG. 4 shows the interior of the flexible waterproofing/impregnation and drying device (1) of the present invention comprising a chamber (2), means for supplying, agitating and/or extracting air (4) to and from the chamber, heat generating units (6), sprayer (18) for applying waterproofing/impregnation fluids onto the items (12) to be waterproofed/impregnated and subsequently dried, a shelf (14) and a support (20) for mounting of a shelf.

In this embodiment the device (1) comprises one shelf and a rotatable sprayer for waterproofing/impregnation the items.

### DESCRIPTION OF THE INVENTION

With reference to the figures, the present invention is described in detail below.

The present invention relates to a a flexible waterproofing/impregnation and drying device 1 for waterproof/impregnating and drying items wherein said flexible device comprises a chamber 2, one or more inlets 10 for introducing waterproofing/impregnation fluid into the chamber, means 4 for supplying air to the chamber, agitating the air inside the chamber and extracting the air from the chamber and one or more heat generating units 6.

The waterproofing/impregnation fluid introduced into the chamber via the one or more inlets 10 may be solvent-based or water-based. Within the scope of the present invention “solvent-based” means any waterproofing/impregnation fluid having an organic or inorganic solvent base other than water.

The air introduced into the chamber 2 may in one embodiment be atmospheric air at atmospheric pressure (around 1 atm) and room temperature (around 25° C.), but may also be air introduced at higher or lower pressure and/or a higher or lower temperature. The means 4 for supplying air into the chamber 2, agitating the air inside the chamber and extracting the air from the chamber may be any means known to the person skilled in the art, such as air fans, air blowers, ventilation systems and air conditioning systems.

In a certain embodiment of the present invention the air introduced into the chamber 2 is supplied via the sprayers 18. This has the advantage that the same inlet may be used for both introducing waterproofing/impregnation liquid and after waterproofing/impregnation to introduce air into the chamber 2. This has the further advantage of cleaning the inlet 10 and the sprayer 18 with air.

The one or more heat generating units 6 of the device are capable of heating the air and/or the surface of the items arranged in the interior of the chamber 2 to at temperature from 20-200° C., such as 40-180° C., for example 50-150° C., such as 75-100° C.

The one or more heat generating units 6 of the device 1 may be chosen among a variety of heat generation units such as heat sources of, but not limited to, infrared light emitting units, ultraviolet light emitting units, microwave units, electrical heaters, fluorescent tubes, heat pumps or any combination thereof. It is within the scope of the present invention that the device 1 may be equipped with only one heat generating unit 6, but also with a plurality of heat generating units (of the same kind or in any combination), in order to maximize the flexibility of the device 1 of the present invention.

When equipped with more than one heat generating the unit 6 it is within the scope of the present invention to apply one or more of said units 6 in combination both in terms of choice of heat source, temperature and duration of heating of the individual heat generating units, depending on the items to be waterproofed/impregnated and dried.

In a certain embodiment of the present invention the heat generating unit 6 and means 4 for supplying air to the chamber 2, agitating the air inside the chamber 2 and extracting the air from the chamber 2 is a single unit, such as an air condition unit.

In another embodiment of the present invention the air introduced into the air is during operation of the device 1 subjected to a dehumidification process and re-introduced into the chamber 2, and thereby recycled dehumidified air is used in the drying process of the present invention.

Hence, the device 1 of the present invention may also comprise and/or be coupled to a dehumidification device.

The device 1 of the present invention may be controlled in multiple ways. The device comprises electrical means 17 for controlling the introduction of waterproofing/impregnation fluid (such as liquid flow rate, pressure and temperature of the liquid), controlling the one or more heat generating units 6 (such as choice of heat source, temperature and duration of drying time), as well as controlling the means 4 for supplying air into the chamber, agitating the air inside the chamber and extracting the air from the chamber (such as air flow rate, pressure, temperature and duration).

The electrical means 17 is controlled and configured by the electronic display and input device 16 present on the front of the device 1, or by remote control, wireless or cabled, by a remote device such as a phone, a tablet, a computer, a cash register and the like. In this way the device 1 is capable of both being controlled and monitored during operation, either on the device itself via the electronic display and input device 16 or remotely by a remote device, wireless or cabled.

The device 1 may comprise rotatable shelves 14 or non-rotatable shelves 14, as well as rotatable sprayers 18 or non-rotatable sprayers 18. Any combination of rotatable and non-rotatable sprayers 18 and rotatable and non-rotatable shelves 14 is useful for waterproofing/impregnating and drying items according to the present invention.

It is within the scope of the present invention that the device 1 may comprise one or more sprayers 18, as well as one or more shelves 14, said shelves suitable to support the items to be impregnated.

In case a shelf is not needed, for example when waterproofing/impregnation and drying items such as coats, jackets, blankets and the like, the device 1 may be fitted with one or more hooks or holding devices attached to the top of the waterproofing/impregnation and drying device 1, in order to fixate the items to be waterproofed/ impregnated and dried. The one or more hooks or holding devices may be rotatable such as to ensure that waterproofing/impregnation fluid is distributed equally on the surface of the items.

Items to be waterproofed/ impregnated and dried are usually subjected to a method of
a. placing said items in the device 1;
b. configuring the device 1 via the electronic display and input device 16 or by remote control of the electrical means 17 to select and control the one or more inlets 10 to control the flow of waterproofing/impregnation fluid into the chamber 2;
c. configuring the device 1 via the electronic display and input device 16 or by remote control of the electrical means 17 to configure the one or more heat generating units 6;
d. configuring the device 1 via the electronic display and input device 16 or by remote control of the electrical means 17 to configure the means 4 for supplying air to the chamber, agitating the air inside the chamber and extracting the air from the chamber;
e. Impregnating and subsequently drying said items for a fixed time period specified by operating the electronic display and input device 16 or by remote control of the electrical means 17 configured to control the device 1.

It is within the scope of the present invention that the method may be controlled, altered, changed and optimized according to the use of the device 1 for impregnating and drying items such as clothes, shoes, bags, purses, blankets, garments and the like.

In an embodiment of the present invention the method may be controlled, altered, changed and/or optimized based upon the environment in the chamber 2 during operation, such as humidity conditions inside the chamber 2.

In a certain embodiment the method of the present invention may be controlled, altered, changed and/or optimized automatically in real-time based upon the environment in the chamber 2 during operation, such as humidity conditions.

The time required for the total process of waterproofing/impregnation and subsequent drying of the items is very short. The time required for the total process for waterproofing/impregnation and subsequent drying is less than 30 minutes, such as less than 25 minutes, less than 20 minutes, even less than 15 minutes, dependent of the items to be waterproofed/impregnated and dried, as well as the choice of waterproofing/impregnation fluid to be used and as well as the choice of heat generating units to be applied in the drying process.

### EXAMPLES

### Example 1

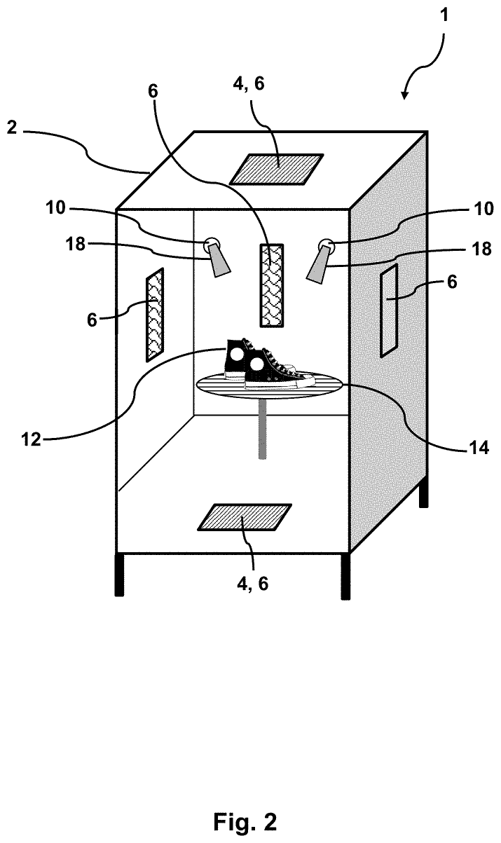

A pair of shoes was placed in the device according to the invention and subjected to the method according to the invention, using a water-based waterproofing/impregnation fluid to waterproof/impregnate the shoes for about 60 seconds. The device was configured according to FIG. 2 with a rotating shelf, two sprayers and heat generating units comprising a microwave unit and an electrical heater. The pair of shoes was fully waterproof and completely dry after 23 minutes of operation of the device according to the invention.

### Example 2

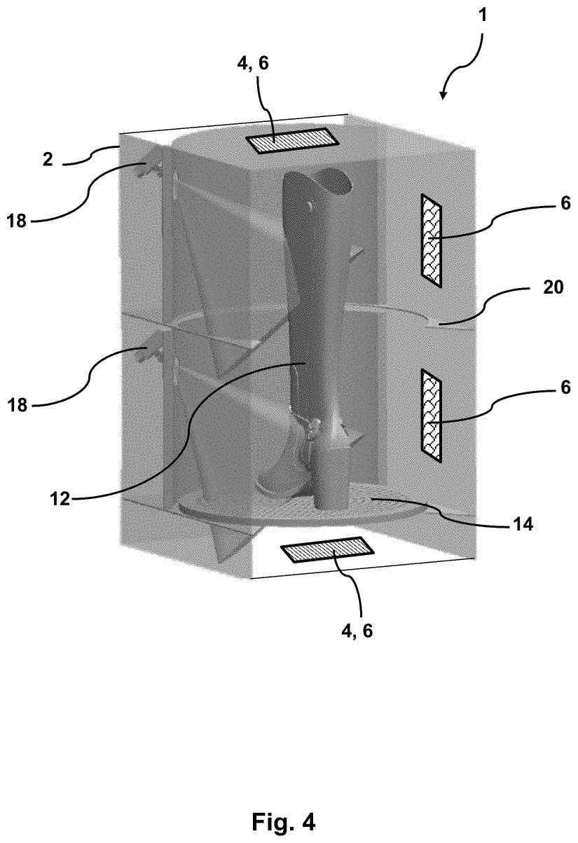

A pair of boots was placed in the device according to the invention and subjected to the method according to the invention, using a solvent-based waterproofing/impregnation fluid to waterproof/impregnate the boots for about 90 seconds. The device was configured according to FIG. 4 with one shelf, a rotatable sprayer and heat generating units comprising a microwave unit, an electrical heater and an ultraviolet light emitting unit. The pair of shoes was fully waterproof and dry after 26 minutes of operation of the device according to the invention.

### Example 3

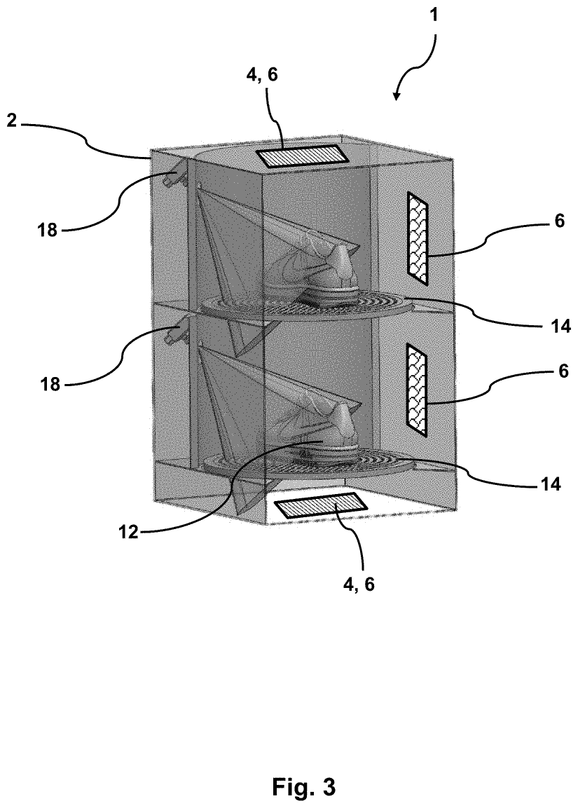

A coat was placed in the device according to the invention and subjected to the method according to the invention, using a water-based waterproofing/impregnation fluid to waterproof/impregnate the coat for about 180 seconds. The device was configured according to FIG. 3 or 4 with a rotatable hook but without shelves, a rotatable sprayer and heat generating units comprising a microwave unit, an air conditioning unit and a fluorescent tube. The coat was fully waterproof and dry after 19 minutes of operation of the device according to the invention.

### Example 4

A device comprising a treatment chamber, in which is arranged a plurality of (movable) nozzles, ventilation means and a heating source or air condition unit is used for waterproofing and drying a pair of shoes. The chamber has a volume of approx. 65 1. The ventilator which is used to agitate the air inside the chamber is controllable to operate at various effects between 0% and 100%. In this example the heater is activated to create an air temperature between 30° and 50° inside the chamber, with the ventilation means at 40% (airspeed approx. 1-1.5 m/s). This condition is maintained between 20 to 50 sec. Thereafter, the ventilation means is reduced to 5-15% effect, and the nozzles are activated creating a mist of impregnating agent directed at the shoes. The nozzles are activated either all together or sequentially, i.e. one or more at a time. This regime is maintained for 5-30 seconds, during which time between 5 ml to 100 ml liquid impregnating agent is pumped through the nozzles and transformed to impregnating mist—directed towards the shoes. After the spraying with waterproofing agent a drying cycle is activated, where the ventilation means is set at between 40% and 75%, the temperature controlled to be between 30° and 50° for a period of up to 60 seconds. At this time the treatment chamber may be opened as the shoes have received a complete impregnation routine, and that the impregnating agent is sufficiently dry for normal use of the shoes. The impregnating agent—depending on the actual agent—may further dry, harden and/or mature.

Other aspects of the invention may include:
that one, two or more platforms are provided vertically displaced relative to each other, inside the chamber, configured to place items to be treated on, where the platforms are provided with motor means allowing the platforms to be rotated around a vertical axis inside the chamber; and/or
that the inlets (10) for introducing waterproofing/impregnation fluid into the chamber is controlled by the electronic display and input device (16) or by remote control of the electrical means (17); and/or
that the one or more inlets comprises one or more nozzles, and where said inlets are connected to a source of impregnating agent by means of conduits, and where emptying means are provided for emptying the conduits of impregnating agent between each activation of the device; and/or
that the emptying means comprises a connection to a source of pressurized gas or a cleaning liquid, such that said pressurized gas or liquid may be introduced into the conduit, ejecting any impregnating agent; and/or
that the impregnating agent is pre-dosed into a mixing chamber by means of a conduit connecting a reservoir of impregnating agent with the mixing chamber, where said mixing chamber is further provided with an air inlet and an air outlet, where said air inlet is connected to a source of air, said air having a pressure higher than the ambient air pressure, and where the air outlet is connected to the one or more nozzles; and/or
that an air compressor is provided for providing the source of air, where the air pressure is selected between 1.3 bar to 5 bars; and/or
that the impregnation agent per treatment in the device is selected between 3 ml and 50 ml; and/or
that the combined air volume of air from the waterproofing/impregnation fluid and air being introduced by the air supplying means, supplies a combined volume during a treatment of objects corresponding to between 3 and 25 times the volume of the chamber; and/or—the use of a flexible waterproofing/impregnation and drying device (1) wherein said items are clothes, shoes, bags, purses, blankets, garments and the like having undergone a solvent-based or water-based waterproofing/impregnation process.
the combination of the heat generating units (6) are configured using electronic display and input device (16) or by remote control of the electrical means (17) dependent on the items to be dried.
the temperature, waterproofing/impregnation time and drying time are configured using the electronic display and input device (16) or by remote control of the electrical means (17) dependent on the items to be waterproofed/impregnated and dried.

1. A waterproofing/impregnation and drying device (1) for waterproofing/impregnating and drying items wherein said device comprises a closed chamber (2) accessible through a door, one or more inlets (10) for introducing waterproofing/impregnation fluid or mist into the chamber, means (4) for supplying and extracting air to/from the chamber, an agitator for agitating the air inside the chamber and where a drying device is provided comprising one or more heat generating units (6).

2. The device (1) according to claim 1 wherein said one or more heat generating units (6) are capable of heating the air and/or the surface of said items arranged in the interior of the chamber (2) to a temperature from 20-200 C.

3. The device (1) according to claim 1 wherein the heat generating unit (6) is an infrared light emitting unit, an ultraviolet light emitting unit, a microwave unit, an electrical heater, a fluorescent tube, a heat pump or any combination thereof.

4. The device (1) according to claim 1 wherein the heat generating unit (6) and means (4) for supplying air to the chamber (2), agitating the air inside the chamber (2) and extracting the air from the chamber (2) is a single unit.

5. The device (1) according to claim 4 wherein said single unit is an air conditioning unit.

6. The device (1) according to claim 1 further comprising electrical means (17) configured to control the device (1) and thereby controlling the heat generating units (6) and the means (4) for supplying air to the chamber, agitating the air inside the chamber (2) and extracting the air.

7. The device (1) according to claim 1 wherein the electrical means (17) is remotely, either wireles sly or cabled, controllable by a remote device, such as a phone, a tablet, a computer, a cash register and the like.

8. The device (1) according to claim 1 wherein said heat generating units (6) are configured to be controlled individually by the electronic display and input device (16) or by remote control of the electrical means (17).

9. The device (I) according to claim 1 wherein the inlets (10) for introducing waterproofing/impregnation fluid into the chamber is controlled by the electronic display and input device (16) or by remote control of the electrical means (17).

10. A method of waterproofing/impregnating and drying items comprising the steps of
a. placing said items in the waterproofing/impregnation and drying device (1) for waterproofing/impregnating and drying items wherein said flexible device comprises a chamber (2), one or more inlets (10) for introducing waterproofing/impregnation fluid into the chamber, and that means (4) for supplying air to the chamber, agitating the air inside the chamber and extracting the air from the chamber, of the device (1) is provided and further that the drying device comprises one or more heat generating units (6),
b. configuring the device (1) via an electronic display and input device (16) or by remote control of the electronic display and input device (16) to select and control the one or more inlets (10) to control the flow of waterproofing/impregnation fluid into the camber (2),
c. configuring the device (1) via the electronic display and input device (16) or by remote control of the electronic display and input device (16) to configure the one or more heat generating units (6);
d. configuring the device (1) via the electronic display and input device (16) or by remote control of the electronic display and input device (16) to configure the means (4) for supplying air to the chamber, agitating the air inside the chamber and extracting the air from the chamber;
e. waterproofing/impregnating and subsequently drying said items for a fixed time period specified by operating the electronic display and input device (16) or by remote control of the electronic display and input de vice (16) configured to control the device (1).

11. The method according to claim 10 wherein the air introduced into the chamber (2) via the means (4) has a relative humidity of less than 80% RH, such as less than 40% RH, preferably less than 25% RH.

12. The method according to claim 10 wherein the temperature of the air and/or the surface of said items arranged in the interior of the chamber (2) is raised to above 50° C., such as above 75° C., such as above 100° C., preferably above 150° C.

13. The method according to claim 11 wherein the total time for waterproofing/impregnation and drying is less than 5 minutes, such as less than 3 minutes, even less than 2 minutes.

14. The method according to claim 10 wherein a further method step (f) is provided where the inlets comprises nozzles connected to a source of impregnating liquid by conduits, and where emptying means are provided for emptying the conduits and cleaning the nozzles between each activation of the device.
